(19) United States
(12) Patent Application Publication
(10) Pub. No.: US 2024/0308193 A1
(43) Pub. Date: Sep. 19, 2024

(54) MULTILAYER DISPERSIBLE AND BIODEGRADABLE COMPOSITE

(71) Applicant: SMARTSOLVE INDUSTRIES LLC, Bowling Green, OH (US)

(72) Inventors: Jonathan Robert Jakubowski, Bowling Green, OH (US); Giuseppe Enrique Giammanco, Jacksonville, FL (US); Gregory Robert Pockat, Ripon, WI (US); Firew T. Gemeda, Bowling Green, OH (US)

(21) Appl. No.: 18/606,838

(22) Filed: Mar. 15, 2024

Related U.S. Application Data
(60) Provisional application No. 63/490,451, filed on Mar. 15, 2023.

(51) Int. Cl. B32B 27/10; B32B 27/08; B32B 27/18; B32B 27/30; B32B 27/36

(52) U.S. Cl. CPC B32B 27/10; B32B 27/08; B32B 27/18; B32B 27/306; B32B 27/36; B32B 2255/10; B32B 2255/12; B32B 2307/31; B32B 2307/7163; B32B 2307/7244; B32B 2307/7246; B32B 2553/00

(57) ABSTRACT

A dispersible and biodegradable composite having a dispersible substrate comprising a water-dispersible paper; and a first biodegradable polymeric film, adjacent a first side of the dispersible substrate, comprising at least one biodegradable component. The dispersible and biodegradable composite may have a second biodegradable polymeric film on the second side of the dispersible substrate. The dispersible and biodegradable composite may be used to form a package. A method of making the dispersible and biodegradable composite includes applying the biodegradable polymeric film to the dispersible substrate.

### FIELD

The present technology relates to water-dispersible and biodegradable composites for items such as packaging materials.

### BACKGROUND OF THE INVENTION

Problems associated with the handling of environmental waste, particularly the large amounts of plastic products and associated packaging discarded each year, have placed added emphasis on developing compostable and biodegradable materials. In particular, packaging waste produced in the food, beverage, agricultural, and personal care industries remains a growing concern. After use, conventional packaging products are typically incinerated or buried in a landfill, each of which can present a serious environmental impact. According to a 2015 publication in Nature, oceanographers estimate that there are between fifteen trillion and fifty-one trillion microplastic particles floating in surface waters worldwide. XiaoZhi Lim, Microplastics are everywhere—but are they harmful? Nature 593, 22-25 (2021).

Biodegradable films can offer benefits over traditional plastic films in terms of reducing waste and environmental impact. However biodegradable films may have limited durability compared to non-biodegradable plastic films. Additionally, biodegradable films may present the potential for contamination if they are not disposed of properly. There are also productivity challenges, as biodegradable films tend to be more difficult and more expensive to produce compared to the non-biodegradable counterpart. Biodegradable films also have limited end-of-life options, as many do not compost nor are they recyclable.

This section serves as background information related to the present disclosure and is not necessarily prior art.

### BRIEF SUMMARY

The present invention is related to articles of manufacture, systems, methods, and processes related to multilayer dispersible and biodegradable composites and packages with the intention to address the shortcomings of current biodegradable composites.

A first aspect includes a dispersible and biodegradable composite, the composite comprising: a dispersible substrate comprising a water-dispersible paper; and a first biodegradable polymeric film, adjacent a first side of the dispersible substrate, comprising at least one biodegradable component. In some embodiments, the dispersible substrate meets a requirement selected from a group consisting of: OECD 301B, ASTM D6868 for biodegradation, ISO 20200 for disintegration, FG502 for flushability, and combinations thereof. Additionally, or alternatively, the first biodegradable polymeric film meets a requirement selected from a group consisting of: ASTM D5511 for anaerobic degradation, ASTM D5988 for soil degradation, ASTM D5271 for freshwater degradation, ASTM D6691 for marine degradation, ASTM D6400 for home/industrial composting, and combinations thereof.

In some embodiments, the dispersible substrate comprises from 60 weight percent to 100 weight percent of a water-dispersible paper.

In some embodiments, the at least one biodegradable component is selected from the group consisting of a polysaccharide, a lipid, a wax, natural fibers, polypeptides, hemicellulose, polycaprolactone, polylactic acid, polyglycolic acid, polybutylene adipate terephthalate, polybutylene succinate, polybutylene succinate adipate, seaweed, polyester, polyamide, a soy-based thermoplastic, polyvinyl alcohol and combinations thereof. In some embodiments, the polyvinyl alcohol is partially hydrolyzed. In some embodiments, the polyvinyl alcohol is fully hydrolyzed.

In some embodiments, the first biodegradable polymeric film further comprises a first additive that provides the composite with improved structure, improved water barrier properties, improved oxygen barrier properties, improved grease barrier properties, or a combination thereof.

In some embodiments, the first biodegradable polymeric film is a multilayer polymeric film.

In some embodiments, the dispersible and biodegradable composite may have a barrier layer between the dispersible substrate and the first biodegradable polymeric film. In some embodiments, the dispersible and biodegradable composite may have a water barrier component selected from the group consisting of: nanocellulose, cellulose stearoyl ester nanoparticles, starch nanocrystals, bentonite, calcium carbonate, a soy-based thermoplastic, and combinations thereof. In some embodiments, the dispersible and biodegradable composite may have a grease barrier component selected from the group consisting of: one or more clay mineral, carboxylated nanofibrilated cellulose, a soy-based thermoplastic, and combinations thereof. Additionally, or alternatively, the dispersible and biodegradable composite may have an oxygen barrier component selected from the group consisting of: nanocellulose, sodium tetraborate decahydrate, calcium carbonate, zinc oxide, bentonite, a casein-based polymer, polyvinyl alcohol, montmorillonite, and combinations thereof. The dispersible and biodegradable composite may have a strengthening agent.

In some embodiments, the dispersible and biodegradable composite may have printing on the dispersible substrate, the first biodegradable polymeric film, or a combination thereof. Additionally, or alternatively, the dispersible and biodegradable composite may have printing on the dispersible substrate, the first biodegradable polymeric film, or a combination thereof.

A second aspect includes a dispersible and biodegradable composite, the fi composite comprising: a dispersible substrate comprising a water-dispersible paper; a first biodegradable polymeric film, adjacent a first side of the dispersible substrate, comprising at least one biodegradable component; and a second biodegradable polymeric film adjacent a second side of the dispersible substrate comprising at least one second biodegradable component.

In some embodiments, the dispersible substrate comprises from 60 weight percent to 100 weight percent of a water-dispersible paper.

In some embodiments, the at least one first biodegradable component and the at least one second biodegradable component are independently selected from the group consisting of a polysaccharide, a lipid, a wax, natural fibers, polypeptides, hemicellulose, polycaprolactone, polylactic acid, polyglycolic acid, polybutylene adipate terephthalate, polybutylene succinate, polybutylene succinate adipate, seaweed, polyester, polyamide, polyvinyl alcohol, and combinations thereof. In some embodiments, the polyvinyl alcohol is partially hydrolyzed. In some embodiments, the polyvinyl alcohol is fully hydrolyzed.

In some embodiments, the first biodegradable composite further comprises an additive. In some embodiments, the second biodegradable composite further comprises an additive. In some embodiments, both the first biodegradable composite and the second biodegradable composite further comprise an additive.

In some embodiments, the first biodegradable composite is a multilayer polymeric film. In some embodiments, the second biodegradable composite is a multilayer polymeric film. In some embodiments, both the first biodegradable polymeric film and the second biodegradable polymeric film are each a multilayer polymeric film.

In some embodiments, the dispersible and biodegradable composite may have a barrier layer between the dispersible substrate and the first biodegradable polymeric film. Additionally, or alternatively, the dispersible and biodegradable composite may have a barrier layer between the dispersible substrate and the second biodegradable polymeric film. In some embodiments, the dispersible and biodegradable composite may have a water barrier component selected from the group consisting of: nanocellulose, cellulose stearoyl ester nanoparticles, starch nanocrystals, bentonite, calcium carbonate, a soy-based thermoplastic, and combinations thereof. In some embodiments, the dispersible and biodegradable composite may have a grease barrier component selected from the group consisting of: one or more clay mineral, carboxylated nanofibrilated cellulose, a soy-based thermoplastic, and combinations thereof. Additionally, or alternatively, the dispersible and biodegradable composite may have an oxygen barrier component selected from the group consisting of: nanocellulose, sodium tetraborate decahydrate, calcium carbonate, zinc oxide, bentonite, montmorillonite, a casein-based polymer, polyvinyl alcohol, and combinations thereof. The dispersible and biodegradable composite may have a strengthening agent.

In some embodiments, the dispersible and biodegradable composite may have printing on the dispersible substrate, the first biodegradable polymeric film, or a combination thereof.

A third aspect includes a package or packaging material formed of the dispersible and biodegradable composite described above.

A fourth aspect includes a method of making a dispersible and biodegradable composite, the method comprising: applying a first biodegradable polymeric film on a first side of a dispersible substrate, wherein the first biodegradable polymeric film comprises at least one biodegradable component. In some embodiments, the method may further include applying a second biodegradable polymeric film on a second side of the dispersible substrate, wherein the second biodegradable component comprises at least one biodegradable component. In some embodiments, applying the first biodegradable polymeric film comprises co-extrusion, slot-die, gravure, hot melt, flexographic, blown film, or combinations thereof. Additionally, or alternatively, applying the second biodegradable polymeric film comprises co-extrusion, slot-die, gravure, hot melt, flexographic, blown film, or combinations thereof.

In some embodiments, the method may further include applying a print layer onto the dispersible substrate, the first biodegradable polymeric film, or a combination thereof. Additionally, or alternatively, the method may further include applying a print layer onto the second biodegradable polymeric film, In some embodiments, applying the print layer comprises digital printing, digital toner printing, inkjet printing, flexography, off-set printing, off-set lithography, rotogravure, large format printing, three-dimensional printing, screen printing, laser printing, thermal transfer printing, direct thermal printing, or combinations thereof.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

The drawings described herein are for illustrative purposes for selected embodiments and not all possible implementations, and are not intended to limit the scope of the present disclosure.

FIG. 1 is a schematic diagram illustrating the water vapor transmission rate (WVTR) and oxygen transmission rate (OTR) for various packaging materials.

FIG. 2A illustrates a composite in accordance with at least one embodiment of the present invention.

FIG. 2B illustrates a composite in accordance with at least one embodiment of the present invention.

FIG. 2C illustrates a composite in accordance with at least one embodiment of the present invention.

FIG. 2D illustrates a composite in accordance with at least one embodiment of the present invention.

FIG. 2E illustrates a composite in accordance with at least one embodiment of the present invention.

FIG. 2F illustrates a composite in accordance with at least one embodiment of the present invention.

FIG. 2G illustrates a composite in accordance with at least one embodiment of the present invention.

FIG. 2H illustrates a composite in accordance with at least one embodiment of the present invention.

### DETAILED DESCRIPTION OF EMBODIMENTS OF THE INVENTION

The following description of technology is merely exemplary in nature of the subject matter, manufacture and use of one or more inventions, and is not intended to limit the scope, application, or uses of any specific invention claimed in this application or in such other applications as may be filed claiming priority to this application, or patents issuing therefrom. Regarding methods disclosed, the order of the steps presented is exemplary in nature, and thus, the order of the steps can be different in various embodiments, including where certain steps can be simultaneously performed. “A” and “an” as used herein indicate “at least one” of the item is present; a plurality of such items may be present, when possible. Except where otherwise expressly indicated, all numerical quantities in this description are to be understood as modified by the word “about” and all geometric and spatial descriptors are to be understood as modified by the word “substantially” in describing the broadest scope of the technology. “About” when applied to numerical values indicates that the calculation or the measurement allows some slight imprecision in the value (with some approach to exactness in the value; approximately or reasonably close to the value; nearly). If, for some reason, the imprecision provided by “about” and/or “substantially” is not otherwise understood in the art with this ordinary meaning, then “about” and/or “substantially” as used herein indicates at least variations that may arise from ordinary methods of measuring or using such parameters

All documents, including patents, patent applications, and scientific literature cited in this detailed description are incorporated herein by reference, unless otherwise expressly indicated. Where any conflict or ambiguity may exist between a document incorporated by reference and this detailed description, the present detailed description controls.

Although the open-ended term “comprising,” as a synonym of non-restrictive terms such as including, containing, or having, is used herein to describe and claim embodiments of the present technology, embodiments may alternatively be described using more limiting terms such as “consisting of” or “consisting essentially of.” Thus, for any given embodiment reciting materials, components, or process steps, the present technology also specifically includes embodiments consisting of, or consisting essentially of, such materials, components, or process steps excluding additional materials, components or processes (for consisting of) and excluding additional materials, components or processes affecting the significant properties of the embodiment (for consisting essentially of), even though such additional materials, components or processes are not explicitly recited in this application. For example, recitation of a composition or process reciting elements A, B and C specifically envisions embodiments consisting of, and consisting essentially of, A, B and C, excluding an element D that may be recited in the art, even though element D is not explicitly described as being excluded herein.

As referred to herein, all compositional percentages are by weight of the total composition, unless otherwise specified. Disclosures of ranges are, unless specified otherwise, inclusive of endpoints and include all distinct values and further divided ranges within the entire range. Thus, for example, a range of “from A to B” or “from about A to about B” is inclusive of A and of B. Disclosure of values and ranges of values for specific parameters (such as amounts, weight percentages, etc.) are not exclusive of other values and ranges of values useful herein. It is envisioned that two or more specific exemplified values for a given parameter may define endpoints for a range of values that may be claimed for the parameter. For example, if Parameter X is exemplified herein to have value A and also exemplified to have value Z, it is envisioned that Parameter X may have a range of values from about A to about Z. Similarly, it is envisioned that disclosure of two or more ranges of values for a parameter (whether such ranges are nested, overlapping or distinct) subsume all possible combinations of ranges for the value that might be claimed using endpoints of the disclosed ranges. For example, if Parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, 3-9, and so on.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The present technology is directed to a composite, packaging materials comprising said composite, and methods of making and using said composite and packaging materials. The composite is constructed from one or more water-dispersible and/or biodegradable compositions. The composite may be a dispersible substrate coated on both sides with a biodegradable polymeric film. The biodegradable polymeric film is coated onto the dispersible substrate in multiple layers. The biodegradable polymeric film may be coated in 1-10 layers. In some embodiments, the biodegradable polymeric film may be coated in 10-100 layers. Additionally, or alternatively, the biodegradable polymeric film may be coated in 100-900 layers. In some embodiments, the biodegradable polymeric film is coated in 1000-10,000 layers.

The dispersible substrate may be coated on both sides with one or more biodegradable polymeric film. The advantage to coating both sides of the dispersible substrate includes increase barrier properties, reduced dispersion, and increase packaging applicability in markets where water is present in the packaged material and/or in the environment.

The term “water-dispersible,” as used herein, refers to the capability of being at least partially soluble and subsequently partially dispersible (e.g., at least about 70% dispersible) to nearly completely dispersible (e.g., about 100% dispersible) in an aqueous solution, such as water. Dispersion can result in fragmentation of the composition into particulate and/or micro-particulate, where a water-dispersible layer or sheet can fall apart in an aqueous solution into such particulate, leaving only 30% or less of the original structure remaining. Water-dispersible materials, as referenced herein, include materials and papers referred to in the art as “water-soluble,” where only a portion of the paper may be actually soluble in water, but dissolution of this soluble portion results in dispersion of most or all of the remaining structure. Water-dispersibility can be related to flushability or dispersibility in water and in waste water handling and treatment systems, including septic and municipal waste treatment systems. Particular requirements for water-solubility include ISO 20200 for disintegration and FG502 for flushability. Suitable water-dispersible material for use in the composite are described in U.S. patent application Ser. No. 18/156,027 and U.S. Pat. No. 11,591,149, which are incorporated by reference herein in their entirety.

The term “biodegradable,” as used herein, refers to materials that can be readily decomposed by biological methods, through a combination of heat, moisture, and/or microbial action. Biodegradation can include environmental as well as deliberate microbial degradation through composting, aerobic digestion, anaerobic digestion, including treatment through municipal waste management systems. Particular requirements for biodegradation include ASTM D6868, OECD 301B, ASTM D5511 for anaerobic degradation, ASTM D5988 for soil degradation, ASTM D5271 for freshwater degradation, ASTM D6691 for marine degradation, and ASTM D6400 for industrial composting. Suitable biodegradable material for use in the composite are described in U.S. patent application Ser. No. 18/156,027 and U.S. Pat. No. 11,591,149, which are incorporated by reference herein in their entirety.

The water-dispersible material of the dispersible substrate and the biodegradable component of the biodegradable polymeric film can be characterized by one or more certifications or standards that define certain parameters and/or thresholds for water-solubility and biodegradability, respectively. Water-dispersibility can be related to flushability or dispersibility in water and in waste water handling and treatment systems, including septic and municipal waste treatment systems. Particular requirements for water-solubility include ISO 20200 for disintegration and FG502 for flushability. Biodegradation can include environmental as well as deliberate microbial degradation through composting, aerobic digestion, anaerobic digestion, including treatment through municipal waste management systems. Particular requirements for biodegradation include ASTM D6868, OECD 301B, ASTM D5511 for anaerobic degradation, ASTM D5988 for soil degradation, ASTM D5271 for freshwater degradation, ASTM D6691 for marine degradation, and ASTM D6400 for industrial composting.

The present technology is directed to a dispersible and biodegradable multilayer composite. Composite, as used herein, refers to a material produced from two or more constituent materials, and more specifically having two or more layers, each formed of a different material. A dispersible, or water-dispersible, substrate is coated with a biodegradable polymeric film. The biodegradable polymeric film may comprise multiple layers. The biodegradable polymeric film may be coated on both sides of the dispersible substrate.

The dispersible substrate can have the following aspects. Certain embodiments include where dispersible substrate comprises one or more dispersible component. The dispersible component may be a water-dispersible paper, such as a cellulosic polymer and/or a plant fiber. Particular examples of cellulosic polymers and plant fibers include carboxymethyl cellulose, a carboxymethyl cellulose salt, and/or wood pulp. In some embodiments, the water-dispersible paper, in particular, can enable printing. Registered print is also possible, where print appears in the same position on successive repeats or on successive sheets or portions of the composite.

In some embodiments the dispersible component may be one or more of: polyvinyl alcohol (fully- and partially-hydrolysed polyvinyl acetate), co-polymers based on polyvinyl alcohol (fully- and partially-hydrolysed vinyl acetate copolymers), cellulose ether, lignin, polymers based on polyvinyl pyrrolidone, polyethylene glycol, xanthan gum, guar gum, polyquaternium polymers, pullulan, hydroxypropylmethyl cellulose, hydroxyethyl cellulose, hydroxypropyl cellulose, gelatine, sodium salt of carboxymethylcellulose, sodium alginate, gum tragacanth, acacia gum, gum arabic, polyacrylic acid, methyl methacrylate copolymer, carboxyvinyl polymer, amylases, natural and modified starches, aluminium starch octenylsuccinate, hydroxypropyl starch phosphates, high amylase starch, high amylase hydroxypropylated starch, dextrin, pectin, chitin, chitosan, levan, elsinan, collagen, zein, gluten, soya protein isolate, milk protein isolate, casein, carob bean gum, karaya gum, carrageenan, gellan gum, agar, alginic acid and alginates, furcellaran, polyhydroxy acid polymers, and mixtures thereof.

The dispersible materials can make up about 60-100 weight percent of dispersible substrate, based on the total weight of dispersible substrate. In addition to the water-dispersible material(s), the dispersible substrate can include one or more additives, such as (but not limited to) plasticizers, stabilizers, pigments, dyes, fillers, processing aids, and the like in an amount of about 0-40 weight percent, based on the total weight of the dispersible substrate.

In some embodiments, the dispersible substrate meets the requirements for one or more internationally recognized protocols, such as ASTM D6400, OECD 301B, ASTM D6868, EN13432, ISO 14885, ISO 17088, ISO 18606, and AS 4736 for biodegradation and compostability, ISO 20200 for disintegration, and/or FG502 for flushability, each of which is incorporated by reference herein in its entirety.

In some embodiments, the dispersible substrate includes additives or fillers. Additives may be plasticizers, stabilizers, fillers, and/or processing aids including extrusion aids. Additives may also include one or more colorants, including pigments and/or dyes. Such additives can be included in the respective layers from about 0.1 wt. % to about 5 wt. %.

The biodegradable polymeric film may include one or more biodegradable components including: polysaccharides, including but not limited to: hyaluronic acid and sodium hyaluronate; lipids; waxes, natural fibers; polypeptides; hemicellulose; polycaprolactone; polylactic acid; polyglycolic acid; polybutylene adipate terephthalate, polybutylene succinate, polybutylene succinate adipate, seaweed, polyesters (aromatic or aliphatic), polyamides (aromatic or aliphatic), and combinations thereof.

Other examples of biodegradable components for the biodegradable polymeric film include: one or more of poly(hydroxybutyrate), poly(hydroxyvalerate), and poly(hydroxybutyrate-co-hydoxyvalerate). Embodiments of the water-dispersible and biodegradable composite can include where the dispersible substrate comprises fully and partially hydrolyzed vinyl acetate polymers and copolymers and where the biodegradable component includes a poly(hydroxyalkanoate). Other embodiments include where the biodegradable material includes poly(butylene succinate). Poly(butylene succinate) can have moisture barrier properties, can be heat sealable, and can be coated onto the dispersible substrate via extrusion coating or using other coating methods, much in the same way poly(hydroxyalkanoates) can be applied.

The biodegradable polymeric film can be tuned to have the desired dispersion and biodegradation profile for the chosen application by selecting specific combinations and ratios of biodegradable components of the biodegradable composite. Additionally, the dispersion and biodegradation profile of the composite can be tuned by including additives, or fillers, in the biodegradable composite. These fillers, may be organic or inorganic fillers, and may enhance the overall dispersibility of the substrate. Examples of additives that may be added to the biodegradable composite to enhance dispersion include, but are not limited to: starch, alginate, nano-cellulose, and carboxymethyl cellulose (CMC).

In some embodiments, dispersible components may be added as fillers to the biodegradable polymeric film to enhance or accelerate biofragmentation and biodegradation. These materials may make “weak-spots” in the biodegradable polymeric film to speed up the biodegradation process. Examples of dispersible components that may be added for weak spots include, but are not limited to: polyvinyl alcohol (fully- and partially-hydrolysed polyvinyl acetate), co-polymers based on polyvinyl alcohol (fully- and partially-hydrolysed vinyl acetate copolymers), cellulose ether, lignin, polymers based on polyvinyl pyrrolidone, polyethylene glycol, xanthan gum, guar gum, polyquaternium polymers, pullulan, hydroxypropylmethyl cellulose, hydroxyethyl cellulose, hydroxypropyl cellulose, gelatine, sodium salt of carboxymethylcellulose, sodium alginate, gum tragacanth, acacia gum, gum arabic, polyacrylic acid, methyl methacrylate copolymer, carboxyvinyl polymer, amylases, natural and modified starches, aluminium starch octenylsuccinate, hydroxypropyl starch phosphates, high amylase starch, high amylase hydroxypropylated starch, dextrin, pectin, chitin, chitosan, levan, elsinan, collagen, zein, gluten, soya protein isolate, milk protein isolate, casein, carob bean gum, karaya gum, carrageenan, gellan gum, agar, alginic acid and alginates, furcellaran, polyhydroxy acid polymers, and mixtures thereof.

In some embodiments, the composite may be tuned to exhibit heat-resistance on one side of the composite and heat sealability on the other side of the composite. In this embodiment, a biodegradable component with a lower melting point would be selected for heat sealability, and a biodegradable component with a higher melting point selected for heat resistance for the opposite side of the composite as the second biodegradable polymeric film.

In some embodiments, one side of the composite may be tuned for printability. In this embodiment, a biodegradable component that results in a glossy surface would be chosen, as glossy surfaces tend to hold ink or other printing media better. Examples of biodegradable components that would be chosen for printability include polyesters and polyamides.

The biodegradable polymeric film may include additional fillers such as plasticizers, stabilizers, fillers, and/or processing aids including extrusion aids and/or coating aids. Additives may also include one or more colorants, including pigments and/or dyes. Such additives can be included in the respective layers from about 0.1 wt. % to about 5 wt. %.

The biodegradable polymeric film may be applied to the dispersible substrate via co-extrusion, slot-die, gravure, hot melt, flexography, blown film, or any other method known in the art.

Registered printing can include the use of registered repeats that use an “eyespot” on the composite or sheet of the composite to allow each print image to be in the same place on each composite or sheet. The eyespot (e.g., a thin 1″ by 0.25″ dark colored rectangle) can be located at a corner of the composite or sheet and can provide a straight line that the printer system machine eye can “catch” and seal in the same place each printing impression, for example. In certain color printing methods, print registration can include layering of printed patterns to form a multicolor pattern, where registration minimizes position misalignment in overlapped patterns. Printing system machine components, such as a print cylinder, doctor blade assembly, printing plates, stress/friction, etc., can affect registration. Notably, the composite provided herein can effectively be subjected to registered printing, unlike other materials including many plastics and polymers that cannot effectively absorb or allow proper drying of inks, which can result in undesirable spreading, smearing, bleeding, poor resolution, among other issues. The water-dispersible substrate can provide a suitable substrate for various registered printing methods, including those employing dye-based and pigment-based aqueous inks.

One or more of the dispersible substrate or biodegradable polymeric layer may be printed with various types of inks, including but not limited to: water-based inks, soy-based inks, vegetable-based inks, bio-based inks, plant-based inks, edible inks, algae inks, digital inks, VOC-free inks, UV-curable inks, and biodegradable inks. Registered printing may be printed onto the biodegradable material using digital printing, a digital toner, inkjet printing, flexography, offset printing, offset lithography, large format printing, 3D printing, screen printing, laser printing, thermal transfer printing, and direct thermal printing.

The term “barrier layer” refers to a film layer that has a low permeability to gases, such as oxygen. Suitable barrier layer materials can include (but are not limited to) polyvinyl alcohol (PVOH), biodegradable polyesters, silicon dioxide, or blends thereof. The barrier layer can dissolve or physically break down into smaller biodegradable pieces when the dispersible substrate dissolves. In some embodiments, the composite may include more than one barrier layer. In some embodiments the barrier layer is incorporated into one or more of the dispersible layer and the biodegradable layer.

As used herein, the term “core layer” can refer to any internal film layer that has a primary function other than serving as an adhesive or compatibilizer for adhering two layers to one another. In some embodiments, the core layer or layers provide the multilayer film with a desired quality, such as, level of strength, modulus, optics, added abuse resistance, and/or specific impermeability. The core layer or layers must be able to physically break down into smaller biodegradable pieces when the dispersible substrate dissolves.

As used herein, the term “tie layer” refers to any internal layer or layers having the primary purpose of adhering two layers to one another. The tie layer or layers must be able to break down into smaller biodegradable pieces when the dispersible substrate dissolves. The tie layer may be polyvinyl alcohol. The tie layer may serve additional functions within the composites in addition to adhering two layers together. For example, the tie layer may provide the composite with barrier properties, for example: moisture barrier properties, oxygen barrier properties, and/or grease barrier properties.

The composite described herein may include a water barrier as a barrier layer. The water barrier layer may include nanocellulose, cellulose stearoyl ester nanoparticles, starch nanocrystals, bentonite, calcium carbonate, and combinations thereof. In some embodiments, the water barrier comprises a soy-based polymer, such as a soy protein bioplastic, epoxidized soybean oil (ESBO), and soy-based coatings.

The composite described herein may include a grease barrier as a barrier layer. The grease barrier layer may include clay minerals such as Illite, clay minerals, carboxylated nanofibrillated cellulose, and combinations thereof.

The composite described herein may include an oxygen barrier layer as a barrier layer. The oxygen barrier layer may include nanocellulose, calcium carbonate, zinc oxide, bentonite, montmorillonite, sodium tetraborate decahydrate, and combinations thereof. In some embodiments the oxygen barrier comprises a milk-based polymer. An example of a milk-based polymer includes a casein and/or caseinate based thermoplastic and/or whey protein based thermoplastics.

The composite described herein may include a strengthening layer as a barrier layer. The strengthening barrier layer may include cloisite sodium, montmorillonite, and combinations thereof.

The composite described herein may have one or more of a tie layer, a core layer, and/or a barrier layer.

The composites described herein may be used for packaging. For example, when packaging a water-based product, the package may be formed of a composite having a water-dispersible layer on the outside of the package and a biodegradable layer on the inside. Additionally, the composite may include a water barrier on either side of the biodegradable layer to protect the water-dispersible layer from the water and moisture on the interior of the package. In another example, the package may be formed of a composite having the water-dispersible layer on the interior of the package and the biodegradable layer on the exterior of the package. If the contents on the interior of the package are sensitive to moisture; for example: rice, bread, or other hygroscopic materials; the composite may include a moisture barrier on either side of the biodegradable layer.

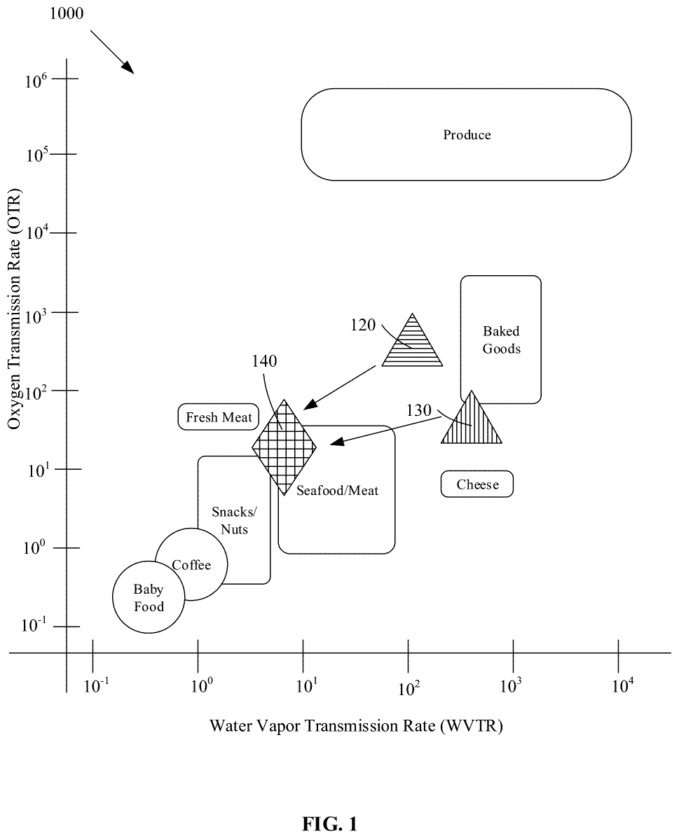

It has been surprisingly shown that the combination of both BioPBS and PVOH in a single composite results in a composite having improved barrier properties. The OTR and WVTR Chart (1000), shown in FIG. 1, illustrates the ideal barrier properties for packaging various materials. For example, baby food would preferably be stored in packaging having a very low oxygen transmission rate (OTR) and a very low water vapor transmission rate (WVTR); whereas produce would preferably be stored in a package that has a relatively high OTR and WVTR compared to baby food or coffee. BioPBS (120) has an OTR of approximately 800-900 cm³/m² 24 h and a WVTR of approximately 100-200 g/m² 24 h. PVOH (130) has an OTR of approximately 40-50 cm³/m² 24 h and a WVTR of approximately 600-700 g/m² 24 h. However, when you combine both BioPBS and PVOH in a composite (140), both OTR and WVTR properties are improved showing an OTR value of approximate 20-30 cm³/m² 24 h and a WVTR value of 20-30 g/m² 24 h.

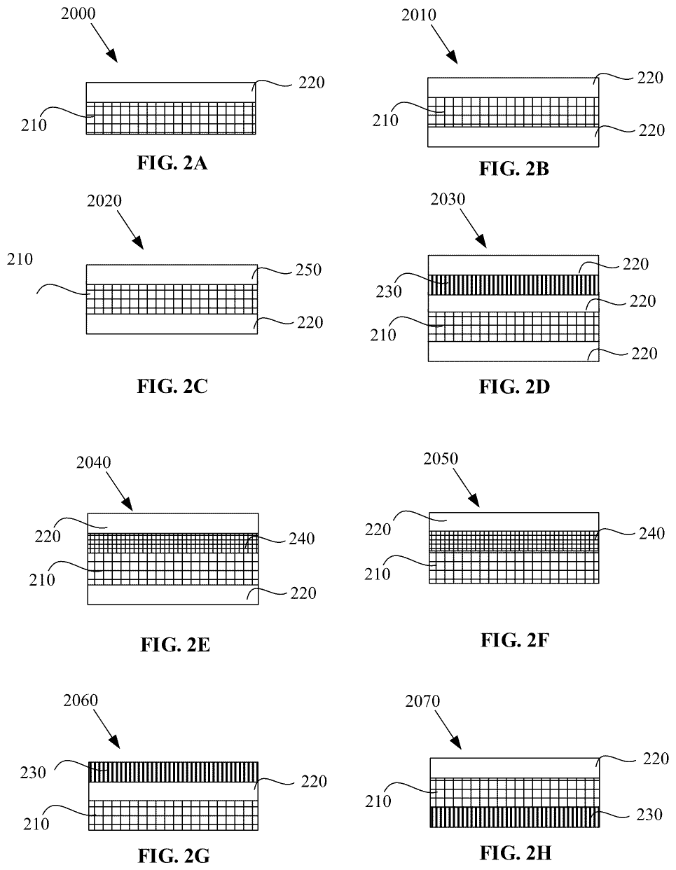

Varying the combinations and amounts of PVOH and BioPBS layers within the dispersible and biodegradable composite can tune the properties of the composite. Non-limiting examples of composites are illustrated in FIG. 2A-H. For example, the composite 2000, shown in FIG. 2A, comprises a dispersible substrate 210 and a biodegradable polymeric film 220. In another example, the composite 2010, shown in FIG. 2B, comprises a dispersible substrate 210, and a first and second biodegradable polymeric film 220 on each side. In another example, the composite 2020, shown in FIG. 2C, comprises a dispersible substrate 210 with a first biodegradable polymeric film 220 on one side and a second biodegradable polymeric film 250 on another side. In another example, the composite 2030, shown in FIG. 2D, comprises a dispersible substrate 210 with a first biodegradable polymeric film 220 on one side having a barrier layer 230 within and a second biodegradable polymeric film 220 on the other side. In another example, the composite 2040, shown in FIG. 2E, comprises a dispersible substrate 210 having a first biodegradable polymeric film 220 on one side, a tie layer 240 on the other side intermediate a second biodegradable polymeric film 220. In another example, the composite 2050, shown in FIG. 2F, comprises a dispersible substrate 210 with a tie layer 240 on one side intermediate a first biodegradable polymeric film 220. In another example, the composite 2060, shown in FIG. 2G, comprises a dispersible substrate 210 with a first biodegradable polymeric film 220 on one side followed by a barrier layer 230. In another example, the composite 2070, shown in FIG. 2H, comprises a dispersible substrate 210 with a first biodegradable polymeric film 220 on one side and a barrier layer 230 on the other side. It should be understood that this list is not exhaustive and there are many other combinations contemplated that fall within the embodiments of the present invention.

Typically, the use of PVOH does not enhance the flushability properties of the water-dispersible substrate. However, it has been found that the use of hydrolyzed PVOH improves the flushability of the overall composite. For example, the PVOH may be fully hydrolyzed. In other examples, the PVOH may be partially hydrolyzed, depending on the desired properties of the composite.

### WORKING EXAMPLES

Oxygen transmission rate (OTR) is measured according to ASTM D3985-2017 testing standard under test condition of temperature 230 C and relative humidity (RH) of 50%. Water vapor transmission rate (WVTR) is measured according to ASTM D1249-20 testing standard under test condition of temperature 230 C and relative humidity (RH) of 50%. Flushability is measured according to a bottle shake test. The bottle shake test includes adding a 2 inch by 2 inch sample of the composite to 1 liter of water in a 2.2-liter bottle, and shaking by hand for 20 seconds. The contents of the bottle are passed through a 25 mm sieve and the mass remaining in the sieve is compared to the original mass of the sample and reported as a percentage. The bottle shake test is comparable to FG502 INDA slosh box test which requires 60% of the original weight of the material to pass through the 12.5 mm sieve. This initial assessment was done to evaluate the potential for various composites to pass the flushability requirement. Our test result (in Example 2 below) of 7% residue after only 20 seconds in 1 Liter of water is an indication that this prototype would also pass the requirement of the standard method.

### Example 1

A biodegradable film with two layers is constructed by melting extrusion coating of biobased polybutylene succinate adipate (BioPBS) on one side and polyvinyl alcohol (PVOH) on the other side on water soluble paper having the oxygen transmission rate and water vapor transmission rate shown in Table 1.

TABLE 1

| | | | Relative | |
|---|---|---|---|---|
| | Total | | Humidity | |
| | Thickness | Temperature | (RH) | |
| | (μm) | (° C.) | (%) | Rate |
| Oxygen | 135.2 | 23 | 50 | 27.02 |
| Transmission | | | | (cm³/m² |
| Rate (OTR) | | | | 24 h) |
| Water Vapor | 139.8 | 23 | 50 | 24.89 |
| Transmission | | | | (g/m² |
| Rate (WVTR) | | | | 24 h) |

### Example 2

A biobased biodegradable film with one layer can be constructed by melting extrusion coating of polyhydroxyalkanoates (PHA) on water-soluble paper. The one layer biobased biodegradable film has the properties shown in Table 2.

TABLE 2

| | Total | | WVTR |
|---|---|---|---|
| | Thickness | Flushability | (23° C., RH |
| | (μm) | (% remaining) | 50%, g/m² 24 h) |
| Example 2 | 254 | 7 | 100 |

### Example 3

The oxygen transmission rate (OTR) and water vapor transmission rate (WVTR) were determined for composites having PVOH. Sample 1 was prepared by extrusion coating 25 μm of BioPBS onto 75 μm of water dispersible paper. Sample 2 was prepared by extrusion coating 15 μm of PVOH onto 75 μm of water dispersible paper. Sample 3 was prepared by extrusion coating 60 μm of PVOH and 34 μm of BioPBS onto 75 μm of water dispersible paper. The OTR and WVTR were determined for each sample, the values are shown in Table 3. It can be seen that the inclusion of PVOH into the composite decreases the rate of oxygen transmission through the composite. Additionally, the incorporation of BioPBS reduces the water vapor transmission through the composite.

TABLE 3

| | | Thickness | | | Oxygen | Water vapor |
|---|---|---|---|---|---|---|
| | Polymer | of water- | Thickness | Thickness | Transmission | Transmission |
| | coated water | dispersible | of | of | Rate | Rate |
| | dispersible | paper | PVOH | BioPBS | (OTR) | (WVTR) |
| | paper | (μm) | (μm) | (μm) | (cm³/m² 24 h) | (g/m² 24 h) |
| 1 | BioPBS coated | 75 | — | 25 | 830 | 116 |
| | water | | | | | |
| | dispersible | | | | | |
| | paper | | | | | |
| 2 | PVOH coated | 75 | 15 | — | 46 | 618 |
| | water | | | | | |
| | dispersible | | | | | |
| | paper | | | | | |
| 3 | BioPBS | 75 | 60 | 34 | 27 | 25 |
| | (on one side) | | | | | |
| | and PVOH | | | | | |
| | (on the | | | | | |
| | other side) | | | | | |
| | coated water | | | | | |
| | dispersible | | | | | |
| | paper | | | | | |

### Example 4

As shown in Table 4, a composite having BioPBS on one side and PVOH on the other may have a weight ratio of BioPBS to water-soluble paper to PVOH of 0.54:0.7:1. Additionally, the thickness ratio of the composite may have a thickness ratio of of BioPBS to water-soluble paper to PVOH 0.45:1:0.75.

TABLE 4

| | GSM | Thickness | Weight ratio | Thickness ratio |
|---|---|---|---|---|
| | (g/m²) | (μm) | (BioPBS: | (BioPBS: |
| Component | range | range | Paper:PVOH) | Paper:PVOH) |
| BioPBS | 38-48 | 29-39 | 0.54:0.7:1 | 0.45:1:0.75 |
| Water- | 55-65 | 70-80 | | |
| dispersible | | | | |
| paper | | | | |
| PVOH | 82-93 | 55-65 | | |

### Example 5

Heat seal data for PVOH containing composites and BioPBS containing composites was obtained. The heat seal data measures the strength of a seal created by sealing the composite using heat. The heat seal strength for composites containing PVOH and composites containing BioPBS are shown in Table 5. The data shows that both PVOH and BioPBS have suitable heat seal strength to secure a package.

TABLE 5

| | | Dwell | | Seal |
|---|---|---|---|---|
| | Temperature | time | Pressure | Strength |
| | (° C.) | (sec) | (KPa) | (g/in) |
| PVOH | 193 | 0.5 | 275 | 1667 |
| | 196 | | | 1937 |
| | 199 | | | 2163 |
| | 201 | | | 2382 |
| | 204 | | | 2326 |
| BioPBS | 140 | 0.5 | 345 | 4308 |
| | 160 | | | 3431 |
| | 180 | | | 2802 |

### Example 6

An example composite 1 comprises 2 μm of water-dispersible substrate and 15 μm of biodegradable polymeric film. An example composite 2 comprises 2 μm of water-dispersible substrate and 60 μm of biodegradable polymeric film. An example composite 3 comprises 3 μm of water-dispersible substrate and 15 μm of biodegradable polymeric film.

TABLE 6

| | Example | | Example | | Example | |
|---|---|---|---|---|---|---|
| | Composite 1 | | Composite 2 | | Composite 3 | |
| Cellulose Pulp | 50-54 | wt % | 50-54 | wt % | 20-30 | wt % |
| (CAS No. | | | | | | |
| 65996-61-4 | | | | | | |
| PVOH | 25-37 | wt % | 60-70 | wt % | 60-65 | wt % |
| (hydrolyzed) | | | | | | |
| (CAS No. | | | | | | |
| 25213-24-5) | | | | | | |
| CM-Cellulose | 4-5 | wt % | 1-3 | wt % | 1-3 | wt % |
| (CAS No. 9000- | | | | | | |
| 11-7) | | | | | | |
| Talc (CAS No. | 2-4 | wt % | 3-6 | wt % | 2-6 | wt % |
| 14807-96-6) | | | | | | |
| Sodium | 0.5-1 | wt % | 0.5 | wt % | 0.5 | wt % |
| Carbonate | | | | | | |
| (CAS-497-19-8) | | | | | | |
| Starch (CAS No. | 0.5-1.3 | wt % | 0.7 | wt % | 0.8 | wt % |

95996-62-5)

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. Equivalent changes, modifications and variations of some embodiments, materials, compositions and methods can be made within the scope of the present technology, with substantially similar results.

1. A dispersible and biodegradable composite, the composite comprising:
a dispersible substrate comprising a water-dispersible paper, wherein the dispersible substrate meets a requirement selected from a group consisting of: OECD 301B, ASTM D6868 for biodegradation, ISO 20200 for disintegration, FG502 for flushability, and combinations thereof; and
a first biodegradable polymeric film, adjacent a first side of the dispersible substrate, comprising at least one biodegradable component, wherein the first biodegradable polymeric film meets a requirement selected from a group consisting of: ASTM D5511 for anaerobic degradation, ASTM D5988 for soil degradation, ASTM D5271 for freshwater degradation, ASTM D6691 for marine degradation, ASTM D6400 for home/industrial composting, and combinations thereof.

2. The dispersible and biodegradable composite of claim 1, wherein the dispersible substrate comprises from 60 weight percent to 100 weight percent of a water-dispersible paper.

3. The dispersible and biodegradable composite of claim 1, wherein the at least one biodegradable component is selected from the group consisting of a polysaccharide, a lipid, a wax, natural fibers, polypeptides, hemicellulose, polycaprolactone, polylactic acid, polyglycolic acid, polybutylene adipate terephthalate, polybutylene succinate, polybutylene succinate adipate, seaweed, polyester, polyamide, a soy-based thermoplastic, polyvinyl alcohol, and combinations thereof.

4. The dispersible and biodegradable composite of claim 1, wherein the first biodegradable polymeric film further comprises a first additive that provides with composite with improved structure, improved water barrier properties, improved oxygen barrier properties, improved grease barrier properties, or a combination thereof.

5. The dispersible and biodegradable composite of claim 1, wherein the first biodegradable polymeric film is a multilayer polymeric film.

6. The dispersible and biodegradable composite of claim 1, further comprising a barrier layer between the dispersible substrate and the first biodegradable polymeric film.

7. The dispersible and biodegradable composite of claim 6, wherein the barrier layer is a water barrier component selected from the group consisting of: nanocellulose, cellulose stearoyl ester nanoparticles, starch nanocrystals, bentonite, calcium carbonate, a soy-based thermoplastic, and combinations thereof.

8. The dispersible and biodegradable composite of claim 6, wherein the barrier layer is a grease barrier component selected from the group consisting of: one or more clay mineral, carboxylated nanofibrillated cellulose, a soy-based thermoplastic, and combinations thereof.

9. The dispersible and biodegradable composite of claim 6, wherein the barrier layer is an oxygen barrier component selected from the group consisting of: nanocellulose, sodium tetraborate decahydrate, calcium carbonate, zinc oxide, bentonite, montmorillonite, a casein-based polymer, polyvinyl alcohol, and combinations thereof.

10. The dispersible and biodegradable composite of claim 6, wherein the barrier layer is a strengthening barrier.

11. The dispersible and biodegradable composite of claim 1, further comprising printing on the dispersible substrate, the first biodegradable polymeric film, or a combination thereof.

12. A dispersible and biodegradable composite, the composite comprising:
a dispersible substrate comprising a water-dispersible paper, wherein the dispersible substrate meets a requirement selected from a group consisting of: OECD 301B, ASTM D6868 for biodegradation, ISO 20200 for disintegration, FG502 for flushability, and combinations thereof, and wherein the first layer provides an interior surface of the package:
a first biodegradable polymeric film, adjacent a first side of the dispersible substrate, comprising at least one first biodegradable component, wherein the first biodegradable polymeric film meets a requirement selected from a group consisting of: ASTM D5511 for anaerobic degradation, ASTM D5988 for soil degradation, ASTM D5271 for freshwater degradation, ASTM D6691 for marine degradation, ASTM D6400 for home/industrial composting, and combinations thereof; and
a second biodegradable polymeric film, adjacent a second side of the dispersible substrate, comprising at least one second biodegradable component, wherein the second biodegradable polymeric film meets a requirement selected from a group consisting of: ASTM D5511 for anaerobic degradation, ASTM D5988 for soil degradation, ASTM D5271 for freshwater degradation, ASTM D6691 for marine degradation, ASTM D6400 for home/industrial composting, and combinations thereof.

13. The dispersible and biodegradable composite of claim 12, wherein the dispersible substrate comprises from 60 weight percent to 100 weight percent of a water-dispersible paper.

14. The dispersible and biodegradable composite of claim 12, wherein the at least one first biodegradable component and the at least one second biodegradable component are independently selected from the group consisting of a polysaccharide, a lipid, a wax, natural fibers, polypeptides, hemicellulose, polycaprolactone, polylactic acid, polyglycolic acid, polybutylene adipate terephthalate, polybutylene succinate, polybutylene succinate adipate, seaweed, polyester, polyamide, a soy-based thermoplastic, polyvinyl alcohol, and combinations thereof.

15. The dispersible and biodegradable composite of claim 12, wherein the first biodegradable polymeric film, the second biodegradable polymeric film, or a combination thereof further comprise at least one first additive.

16. The dispersible and biodegradable composite of claim 12, wherein the first biodegradable polymeric film, the second biodegradable polymeric film, or a combination thereof is a multilayer polymeric film.

17. The dispersible and biodegradable composite of claim 12, further comprising a barrier layer between the dispersible substrate and the first biodegradable polymeric film, between the dispersible substrate and the second biodegradable polymeric film, or between the dispersible substrate and both the first biodegradable polymeric film and the second biodegradable polymeric film.

18. The dispersible and biodegradable composite of claim 17, wherein the barrier layer is a water barrier component selected from the group consisting of: nanocellulose, cellulose stearoyl ester nanoparticles, starch nanocrystals, bentonite, calcium carbonate, a soy-based thermoplastic, and combinations thereof.

19. The dispersible and biodegradable composite of claim 17, wherein the barrier layer is a grease barrier component selected from the group consisting of: one or more clay mineral, carboxylated nanofibrillated cellulose, a soy-based thermoplastic, and combinations thereof.

20. The dispersible and biodegradable composite of claim 17, wherein the barrier layer is an oxygen barrier component selected from the group consisting of: nanocellulose, sodium tetraborate decahydrate, calcium carbonate, zinc oxide, bentonite, montmorillonite, a casein-based polymer, polyvinyl alcohol, and combinations thereof.

21. The dispersible and biodegradable composite of claim 17, wherein the barrier layer is a strengthening barrier.

22. The dispersible and biodegradable composite of claim 12, further comprising printing on the dispersible substrate, the first biodegradable polymeric film, the second biodegradable polymeric film, or a combination thereof.

23. A package comprised of the composite of claim 1.

24. A method of making a dispersible and biodegradable composite, the method comprising:
applying a first biodegradable polymeric film on a first side of a dispersible substrate, wherein the first biodegradable polymeric film comprises at least one biodegradable component.

25. The method of claim 24, further comprising:
applying a second biodegradable polymeric film on a second side of the dispersible substrate, wherein the second biodegradable polymeric film comprises at least one biodegradable component.

26. The method of claim 24, wherein applying the first biodegradable polymeric comprises co-extrusion, slot-die, gravure, hot melt, flexographic, blown film, or combinations thereof.

27. The method of claim 24, further comprising:
applying a print layer onto the dispersible substrate, the first biodegradable polymeric film, or a combination thereof.

28. The method of claim 27, wherein applying the print layer comprises digital printing, digital toner printing, inkjet printing, flexography, off-set printing, off-set lithography, rotogravure, large format printing, three-dimensional printing, screen printing, laser printing, thermal transfer printing, direct thermal printing, or combinations thereof.
